(19) United States
(12) Patent Application Publication
(10) Pub. No.: US 2020/0069106 A1
(43) Pub. Date: Mar. 5, 2020

(54) COFFEE FILTER MACHINE, AND SYSTEM WHICH COMPRISES THE COFFEE FILTER MACHINE

(71) Applicant: Bean Industries Limited, Gloucester (GB)

(72) Inventor: Dirk Hagen Zimmermann, Dusseldorf (DE)

(21) Appl. No.: 16/493,486

(22) PCT Filed: Mar. 14, 2018
(86) PCT No.: PCT/EP2018/056419

§ 371 Date: Sep. 12, 2019

(30) Foreign Application Priority Data
Mar. 15, 2017 (DE) 20 2017 001 402.5

(51) Int. Cl. A47J 31/44; A47J 31/42; A47J 31/06

(52) U.S. Cl. CPC A47J 31/4467; A47J 31/06; A47J 31/42

(57) ABSTRACT

Coffee filter machine (10, 30) comprising a main body (12, 32), a coffee filter holder (14, 34), which is designed to hold a coffee filter, and a receptacle device (16, 36), which is arranged above the coffee filter holder (14, 34) and is designed to detachably accommodate a module for coffee storage (70, 80, 90). A coffee filter machine system (60) comprises the coffee filter machine (10, 30) and at least one of the following modules for coffee storage: storage container (70), coffee powder metering unit (80), coffee grinder (90).

The present invention relates to a coffee filter machine. The invention furthermore comprises a coffee filter machine system comprising the coffee filter machine and at least one module.

Coffee filter machines permit the automated preparation of filter coffee. For this purpose, coffee powder is poured in the desired quantity into a coffee filter. A water reservoir is filled with a corresponding quantity of water. After switching on the coffee filter machine, the water is heated in portions and the brewing water drips onto the coffee powder. After passing through the coffee powder and the coffee filter, the finished brewed coffee drips into a provided coffee pot.

Before the brewing of the coffee, the coffee powder has to be poured from above into the coffee filter. For this purpose, the user conventionally holds a vessel in one hand, in which the coffee powder is located, and holds a metering spoon in the other hand, in order to pour in the coffee powder in the desired quantity. A lid located on the vessel has to be put down somewhere or also held in the hand, if it is not a folding lid. It is desirable to also be able to safely put down the vessel having the coffee powder, even if there is limited space around the coffee filter machine.

Moreover, the number of the coffee powder portions which is poured in has to be carefully counted in the preparation of larger quantities of coffee. Incorrectly measured quantities often occur in this case due to distraction during the pouring process. The quantity which is heaped onto a metering spoon also always differs somewhat. It is therefore desirable to pour the quantity of coffee powder required for the respective application, i.e., for the respective quantity of coffee to be prepared, in a metered and automated manner into the filter.

Ground coffee loses taste over time. Coffee beans represent a better storage form for coffee than coffee powder. The use of coffee powder ground fresh from coffee beans for coffee preparation results in a better coffee quality. The required quantity of coffee beans is then to be ground fresh in each case for the preparation of coffee and then the freshly ground coffee powder is to be poured into the filter. An additional coffee grinder is required for this purpose. It is desirable to be able to expand a coffee filter machine with a coffee grinder.

There are already coffee machines having bean container and integrated grinding mechanism, but they are not constructed modularly, but rather grinding mechanism and machine form a permanently installed unit. Coffee powder always has to be ground first. The use of finished ground coffee powder is not possible.

For these and other reasons, there is a need for the present invention.

The goals and features of the present invention will become clear in the following description of exemplary embodiments, which is performed with reference to the appended figures, in which:

FIG. 1 shows a frontal view of a coffee filter machine according to a first embodiment;

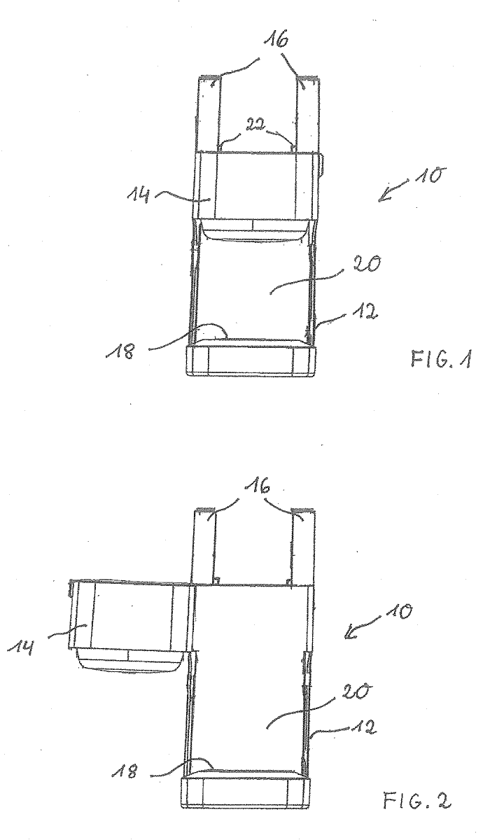

FIG. 2 shows a frontal view of the coffee filter machine of FIG. 1 having the coffee filter holder pivoted to the side;

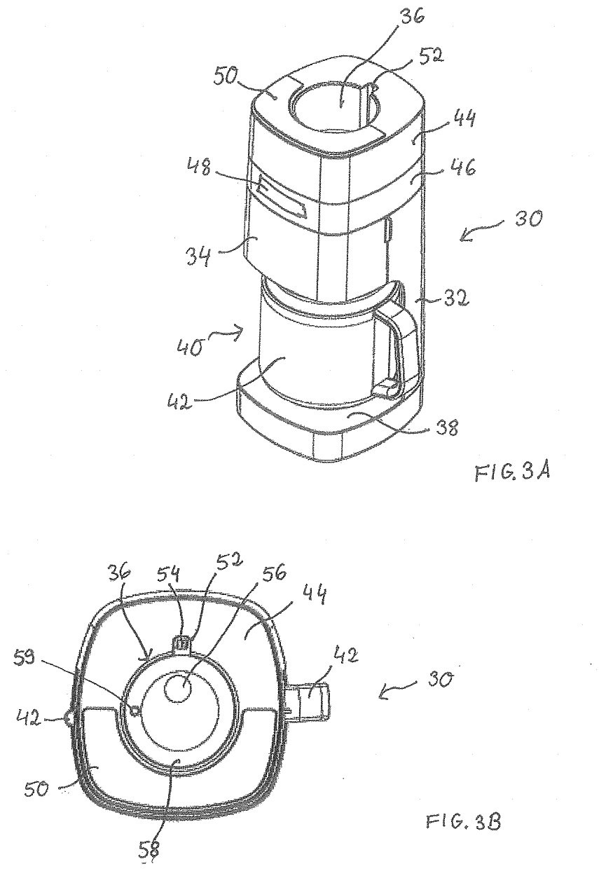

FIG. 3A and FIG. 3B show a further embodiment of a coffee filter machine in a perspective view and in a top view;

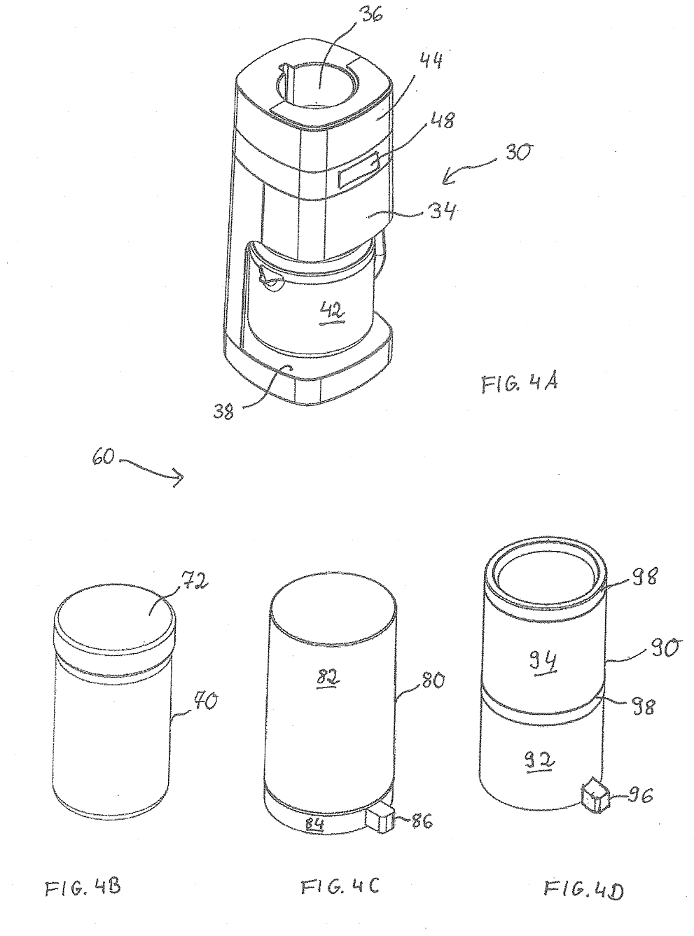

FIG. 4A to FIG. 4D show a coffee filter machine system having a coffee filter machine and three optional modules, each in a perspective view;

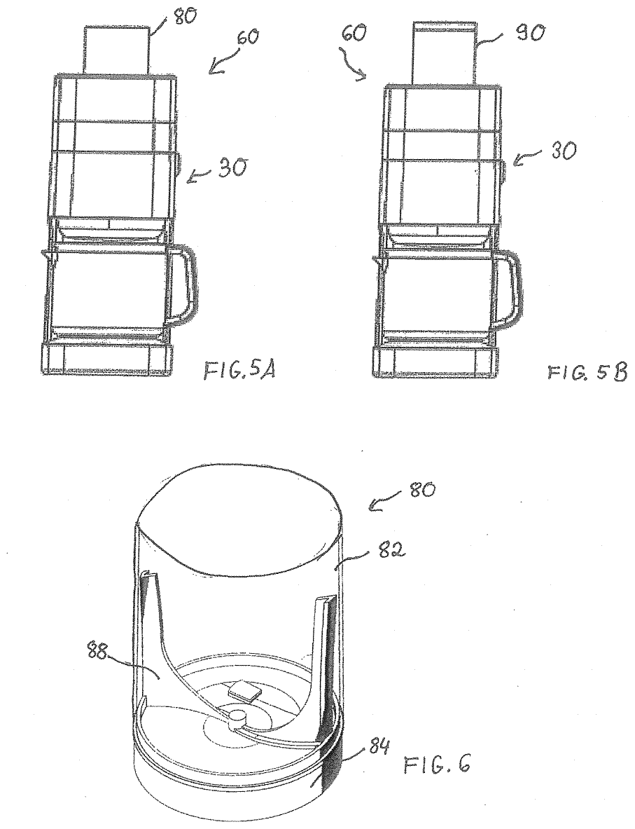

FIG. 5A and FIG. 5B show the coffee filter machine system of FIG. 4 having a differently mounted module in each case;

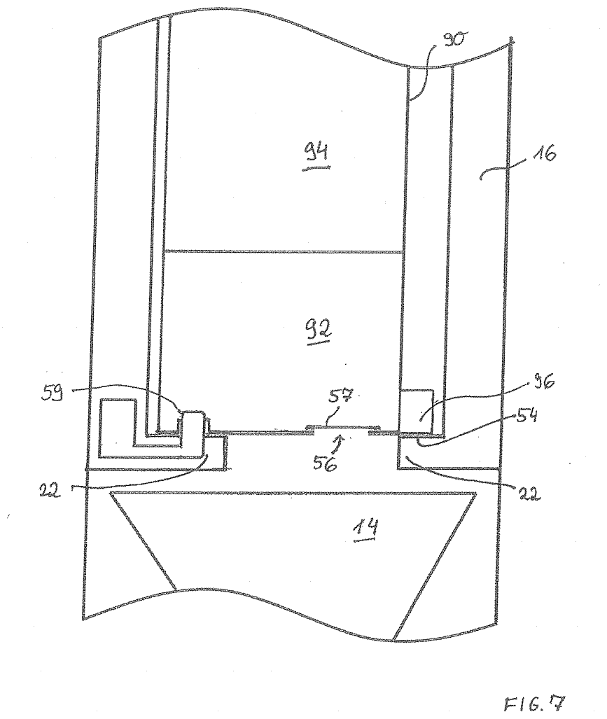

FIG. 6 illustrates a detail of a coffee powder metering unit as a module of a coffee filter machine system;

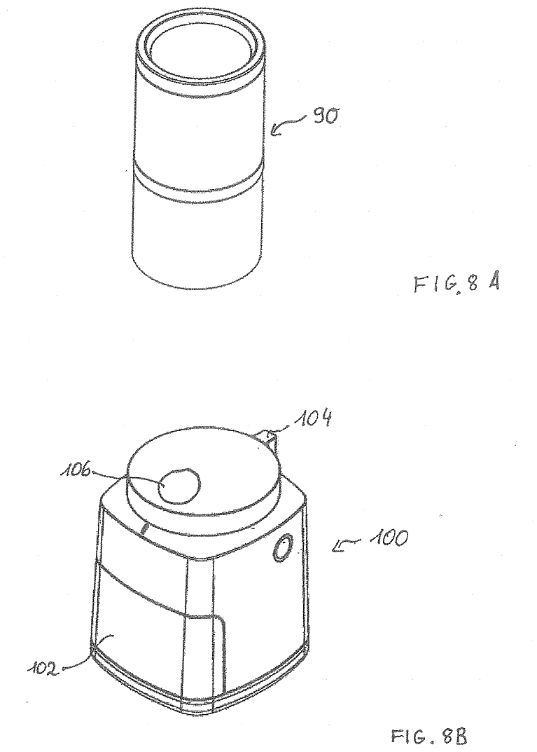

FIG. 7 schematically shows an interface between a module and a coffee filter machine;

FIG. 8A and FIG. 8B show a coffee grinder system comprising a coffee grinder and a coffee grinder base.

Aspects and embodiments are described hereafter with reference to the drawings, wherein identical or similar reference signs are generally used to refer to identical or similar elements. Numerous specific details are described in the following description to offer a fundamental comprehension of one or more aspects of the embodiments. However, it can be obvious to a person skilled in the art that one or more aspects of the embodiments can be embodied using a smaller number of the defined details. In further cases, elements are shown in schematic form to facilitate the description of one or more aspects of the embodiments. The following description is therefore not to be interpreted as restrictive. It is to be noted that the illustration of the various elements in the figures is not necessarily to scale.

The following invention provides a coffee filter machine as claimed in the subject matter of independent claim 1. Preferred exemplary embodiments of the invention result from the dependent claims, the following description, and the drawings. The present invention furthermore provides a coffee filter machine as claimed in the subject matter of independent claim 11. Preferred exemplary embodiments of the coffee filter machine result from the dependent claims, the following description, and the drawings. The present invention furthermore provides a coffee grinder system as claimed in the subject matter of independent claim 23.

Directional terminology used in the description with reference to the drawings, for example, “upper”, “lower”, “upper side”, “lower side”, “left”, “right”, “front side”, “rear side”, “vertically”, “horizontally”, etc. is not to be understood as restrictive. Components of embodiments can be positioned in a number of different alignments, the directional terminology is used solely for explanation. It is apparent that further embodiments can be used and structural or logical changes can be performed without deviating from the concept of the present invention.

A coffee filter machine according to the present invention can comprise a main body. The main body can comprise a substantially circular footprint. The main body can comprise a substantially square footprint. The main body can comprise an arbitrary footprint.

The main body can be manufactured from plastic. In particular, the main body can be manufactured from injection-molded plastic parts. The main body can also be manufactured from other materials, for example, metal. The main body can be manufactured from different materials. The main body can be designed to accommodate a coffee pot. The main body can comprise a heating plate. The main body can be designed so that the coffee pot stands on the heating plate. The coffee pot can be manufactured from glass, porcelain, metal, or a similar suitable material. The coffee pot can be a thermos pot. The heating plate can be switched off when the thermos part is placed thereon.

A coffee filter machine according to the present invention can comprise a coffee filter holder, which is designed to hold a coffee filter. The coffee filter holder can be permanently connected to the main body. The coffee filter holder can be pivotably fastened on the main body. The coffee filter holder can be fastened on the main body so it is pivotable around a substantially vertical axis. The coffee filter holder can be detachably connected to the main body, whereby cleaning is facilitated, for example. A paper coffee filter can be inserted into the coffee filter holder. A permanent coffee filter can be inserted into the coffee filter holder.

The coffee filter holder can be arranged on the main body so that coffee drips out of the coffee filter into the placed coffee pot.

A coffee filter machine according to the present invention can comprise a receptacle device, which is designed to detachably accommodate a module for coffee storage. The receptacle device can be arranged above the coffee filter holder. The receptacle device can be designed as a receptacle opening. The receptacle opening can be substantially cylindrical. The receptacle device can be designed to essentially accommodate modules having a circular bottom. The receptacle device can be open on top, so that a module can be placed from above into the receptacle opening. The receptacle device can be designed to accommodate a laterally inserted module. The receptacle device can be open facing away from the coffee filter holder.

The receptacle device can comprise an electrical interface, which enables an electrical energy transmission between an accommodated module and the main body of the coffee filter machine. The receptacle device can comprise an electrical interface, which enables an electrical signal transmission from the main body to the module or vice versa. Both the energy transmission and also the signal transmission can be unidirectional or bidirectional.

The receptacle device can comprise a mechanical interface, which enables a mechanical energy transmission from the main body of the coffee filter machine to an accommodated module. The receptacle device can comprise a mechanical interface, which enables a mechanical energy transmission from the module to the main body. The receptacle device can comprise a mechanical interface, which enables a mechanical signal transmission from the main body to the module and vice versa.

A coffee filter machine according to the present invention can comprise an electronic control unit. The electronic control unit can be arranged above the coffee filter holder. The electronic control unit can comprise a display screen. The electronic control unit can comprise a human-machine interface, using which operation of the coffee machine is possible. The electronic control unit can comprise a touch-sensitive display screen, also called a touchscreen. A control of the functions of the coffee filter machine can be carried out via the touchscreen. The electrical interface of the receptacle device can be coupled to the electronic control unit. An item of information about the type of the inserted module for coffee storage can be transmitted to the electronic control unit via the electrical interface. An activation of the inserted and/or accommodated module for coffee preparation can take place via the electrical interface. A control of the coffee filter machine can also take place via external devices, for example, a remote control or a mobile telephone. The signal transmission can take place wirelessly via electromagnetic waves. A Bluetooth interface is possible.

A coffee filter machine according to the present invention can comprise a sensor device which is designed to detect whether a module is inserted. The sensor device can furthermore be equipped to detect which type of module is inserted.

A coffee filter machine according to the present invention can comprise a water container. The water container can be detachably connected to the main body. The water container can comprise a lid, which can be removed to pour water into the water container. The lid of the water container can be pivotably fastened on the water container. The receptacle opening for a module can be arranged in the water container. The receptacle opening can be arranged centrally in the water container. In other words, the water container can be formed substantially ring-shaped, wherein the receptacle opening is arranged in the ring center.

A coffee filter machine according to the invention can comprise a coffee filter machine as described above and claimed in claims 1 to 10. A coffee filter machine according to the present invention can furthermore comprise at least one of the following modules for coffee storage: a storage container, a coffee powder metering unit, a coffee grinder.

A storage container according to the invention can be inserted into the receptacle device so that the storage container is closed in a direction toward the coffee filter holder. The storage container can be designed so that it permits a removal of coffee powder from the storage container while the storage container is held in the receptacle device. The necessity is thus dispensed with of having to hold the storage container in a hand while the coffee filter is filled. For example, the coffee filter can be pivoted out and then the coffee powder can be taken from the storage container, which is held in the receptacle device, and decanted into the filter.

A storage container can be embodied as reclosable using a lid. A storage container can be a coffee can, for example, as can be purchased in retail sale filled with coffee powder. A storage container can be designed to be filled with coffee powder.

A coffee powder metering unit can be inserted according to the present invention into the receptacle device. A coffee powder metering unit can comprise a first part, which is configured to accommodate coffee powder, and can comprise a second part, which is configured to dispense the coffee powder in a metered manner in the direction of the coffee filter holder.

The first part of the coffee powder metering unit can be configured to accommodate a container having coffee powder. For this purpose, the first part can comprise a cylinder open on top, into which a container available in retail sale, for example, which is already filled with coffee powder, can be inserted and held. This container is then inserted into the first part having an opening downward, so that coffee powder is available to the second part of the coffee powder metering unit. In another embodiment, the first part can be configured to be directly filled with loose coffee powder.

The first part comprises an opening in the direction of the second part. The first part can comprise a stirring device for storing the coffee powder. A stirring device avoids clamping of the coffee powder and ensures that the coffee powder can be dispensed uniformly in the direction of the second part. The stirring device can also be designed for directly pouring the coffee powder into the second part.

The second part can comprise a metering device and a drive for the metering device. The metering device can comprise a measuring volume, which is alternately filled from the top, i.e., from the first part, with coffee powder and then dispenses the poured-in coffee powder downward into the coffee filter or into the coffee filter holder. The drive for the metering device can alternately control release of an upper opening for filling the measuring volume and a lower opening for coffee powder dispensing. The coffee powder metering unit and in particular the second part having the metering device and the drive can be connected via the electrical interface to the main body of the coffee filter machine. Electrical energy for the drive of the metering device can be provided via the interface. The electronic control unit can activate the metering device via the electrical interface, for example, establish how frequently the measuring volume is to be filled and emptied into the coffee filter. It can be communicated to the electronic control unit via the electrical interface that a coffee powder metering unit is inserted into the receptacle device. With a coffee powder metering unit, the necessity is dispensed with of pouring coffee powder into the coffee folder by hand. The user can preselect via the control unit, for example, via the touchscreen, how many cups of coffee he wishes to brew. The electronic control unit then actuates the drive for the metering device accordingly.

In another embodiment, the second part can comprise a metering device, and the coffee filter machine can be equipped with a drive for the metering device. A coupling between the drive in the coffee filter machine, which is arranged in the main body, for example, can be produced via the mechanical interface. The drive can comprise, for example, an electric motor and a gearing coupled to the electric motor. A part of the gearing can project into the second part and ensure the mechanical coupling.

The first part of the coffee powder metering unit and the second part of the coffee powder metering unit can be detachably connected to one another. In another embodiment, the first and the second part can be permanently connected to one another. In one embodiment, the coffee powder metering unit comprises a direct human-machine interface. For example, a user can press a button on the coffee powder metering unit in accordance with the quantity of measuring volumes which he wishes to pour into the coffee filter. Without having to remove the coffee powder metering unit from the receptacle device, the metered coffee powder falls directly into the coffee filter in this case.

A coffee grinder can be inserted according to the present invention into the receptacle device. The coffee grinder can comprise a grinding mechanism and a coffee bean container. The grinding mechanism and the coffee bean container can be detachably connected to one another. In another embodiment, grinding mechanism and coffee bean container are permanently connected to one another.

The coffee bean container can be configured to accommodate a can having coffee beans. In this case, the can having coffee beans, as can be acquired by purchase in retail sale, for example, is introduced into the coffee bean container having an opening in the direction of the grinding mechanism. In another embodiment, the coffee bean container is designed to accommodate loose coffee beans. Coffee beans can fall into the grinding mechanism from the coffee bean container.

The grinding mechanism can comprise a grinding degree setting to be actuated manually. A grinding mechanism according to the invention can comprise an electrical interface, via which it is electrically coupled to the coffee filter machine. In one embodiment, the electronic control unit of the coffee filter machine can activate the grinding mechanism. The activation of the grinding mechanism can include a grinding degree setting. The grinding mechanism can communicate via the electrical interface to the electronic control unit which module it is. The grinding mechanism is designed to grind coffee beans. The ground coffee beans, i.e., the coffee powder, falls from the grinding mechanism inserted into the receptacle device into the coffee filter.

A closure element can be provided between grinding mechanism and coffee filter. The closure element can be formed as a flap or as a double closure. The closure element can prevent the penetration of moisture, for example, water vapor, into the grinding mechanism and the coffee bean container. The closure element can keep the coffee beans fresh. Opening and closing of the closure element can be coupled to the usage of the grinding mechanism. The opening and closing of the closure element can be controlled independently.

In one embodiment, metering of the coffee powder can be regulated via a duration of the grinding procedure of the grinding mechanism. In another embodiment, the coffee beans can fall in a metered manner into the grinding mechanism. In a further embodiment, the grinding mechanism can comprise a metering device for the ground coffee powder, similarly to the coffee powder metering unit.

In one embodiment, the system can furthermore comprise a coffee grinder base. The coffee grinder base can be designed to accommodate the coffee grinder and supply it with electrical energy. The coffee grinder base can comprise a receptacle container, which is arranged so that it can collect the coffee powder ground by the grinding mechanism. Using the coffee grinder base, the coffee grinder can be operated as an independent unit, independently of the coffee filter machine. It is thus possible to also grind coffee for other applications using the coffee grinder, for example, to supply an espresso machine with coffee powder.

One advantage of the modularly constructed system according to the invention is that in a first expansion stage, for example, the system solely comprises a storage container, which is adapted to the receptacle device. Having to hold or put down the storage container when pouring coffee powder into the coffee filter is dispensed with. In a further expansion stage, for example, a coffee powder metering unit can be added thereto. The pouring in of coffee powder is thus significantly facilitated once again. In the case of a coffee grinder expansion, freshly ground coffee powder is poured into the coffee filter, so that the flavor can unfold particularly well. It is to be understood that, of course, the coffee filter machine can also only contain the coffee grinder or also only the coffee powder metering unit as a module.

It can be advantageous, for example, to operate the coffee grinder together with a coffee grinder base in order to produce coffee powder at a time of day at which the noise linked to the grinding of coffee does not disturb anyone. The coffee powder can then be decanted into the coffee powder metering unit and a quieter preparation of the coffee can take place at an early hour. The electronic control unit is advantageously equipped with a time switch. The preparation of the morning coffee can thus already be programmed in the evening. In one embodiment, in a weekly mode, the coffee preparation can be programmed beforehand for every day of the week. In this case, the coffee powder remains in the coffee powder metering unit until the morning and thus remains more flavor-protected than if the coffee were already poured into the filter in the previous evening.

FIG. 1 shows a coffee filter machine 10 having a main body 12, a coffee filter holder 14, and a receptacle device 16 in a frontal view according to a first embodiment. The main body 12 can comprise a heating plate 18. A coffee pot can be placed on the heating plate 18 in a recess 20. In embodiments in which the coffee pot is a thermos part, the heating plate 18 can be omitted. In embodiments in which both a thermos pot and also a glass or porcelain pot is provided, the heating plate can be alternately turned on or off. Turning the heating plate on or off can be automatically controlled via a pot detection. The coffee filter holder 14 is arranged above the recess 20 for the coffee pot. The coffee filter holder can be pivotably fastened on the main body 12.

FIG. 2 shows the coffee filter machine 10 from FIG. 1, also in a frontal view, having coffee filter holder 14 pivoted out. In the position shown in FIG. 2, a coffee filter can be inserted into the coffee filter holder. Manual pouring of coffee powder into the coffee filter can also be performed in this position.

The receptacle device 16 is arranged above the coffee filter holder and does not change its position when the coffee filter holder 14 is pivoted out. The receptacle device 16 can solely consist of two lateral supports, as schematically shown in FIGS. 1 and 2, which can be embodied as slightly rounded, for example, to ensure a secure hold for a module for coffee storage. The receptacle device 16 can comprise a pedestal 22, on which the module for coffee storage can be positioned. The receptacle device 16 is designed to detachably accommodate a module for coffee storage, wherein this module can be a storage container, a coffee powder metering unit, or a coffee grinder.

A water container is not shown in FIGS. 1 and 2. It can be arranged, for example, behind the opening for the coffee pot and behind the coffee filter holder.

FIG. 3A shows a perspective view of a coffee filter machine 30 according to a second embodiment. FIG. 3B shows the coffee filter machine 30 in a top view. The coffee filter machine 30 comprises a main body 32, a coffee filter holder 34, and a receptacle device 36. The coffee filter machine 30 can also be equipped with a heating plate 38. A coffee pot 42 is placed in an opening 40 between heating plate 38 and coffee filter holder 34. The coffee filter machine 30 furthermore comprises a water container 44 and an electronic control unit 46 having a display screen 48. In the illustrated embodiment, the electronic control unit 46 is arranged between coffee filter holder 34 and water tank 44. It is to be understood that in other embodiments the electronic control unit can also be arranged at another position. The display screen 48 can be designed as a touch-sensitive display unit and can be used as a human-machine interface for the overall operation of the coffee filter machine 30.

The water container 44 is formed substantially ring-shaped. The receptacle device 36 is formed in the center as a receptacle opening open on top. The receptacle opening 36 is substantially cylindrical having a circular bottom. The water container 44 is provided with a lid 50, which can be folded open, pushed open, removed, or opened in another manner to pour water into the water container. The water tank or water container 44 can be designed as removable as a whole, for example, removable upward. However, it can also be permanently connected to the main body 32.

The receptacle opening 36 can comprise a groove 52, which can effectuate an alignment of the module to be inserted. Furthermore, the groove 52 can be designed to accommodate a plug or a plug device of an electrical interface of the module and ensure a correct contact with an electrical interface of the main body 32.

Parts of the coffee pot 42 and the water container 44 with its lid 50 can be seen in the top view of FIG. 3B. FIG. 3B permits a view into the receptacle opening 36. An electrical interface 54 is arranged at the bottom of the groove 52. Modules which comprise a corresponding plug device can be supplied with electrical energy via the electrical interface 54. Modules which are designed accordingly can exchange data with electronic control unit 46 via the electrical interface 54. Thus, for example, the module can announce its identifier or its type via the electrical interface 54. The electronic control unit 46 can activate a metering device or supply a grinding mechanism with electrical current via the electrical interface 54, for example. Furthermore, an opening 56, which enables a transfer of coffee powder directly into the coffee filter located underneath, is at the bottom of the receptacle opening 36. A sensor 58 can be provided to detect whether a module is inserted at all. In one embodiment, the module can also detect the type of module which is inserted. A mechanical interface 59 is also indicated. A mechanical force transmission is possible via the mechanical interface 59, which can establish a contact between a gearing in the main body and a module.

FIG. 4A to FIG. 4D show a coffee filter machine system 60 comprising a coffee filter machine, which can be the coffee filter machine 30. It is to be understood that the coffee filter machine 10 can also be part of the coffee filter machine system. The coffee filter machine system 60 includes, in addition to the coffee filter machine 30, at least one of the following modules for coffee storage: a storage container 70, a coffee powder metering unit 80, a coffee grinder 90.

The storage container 70 comprises a lid 72. The lid 72 can be a screw top lid. The lid 72 can also be a pressure cap lid. The lid 72 can be connected to the storage container 70 in the open state. The storage container 70 can be inserted into the receptacle opening 36 in the alignment in which it is shown in FIG. 4B. The storage container 70 is closed in the direction toward the coffee filter holder 34. The storage container 70 permits, when the lid 72 is removed and/or opened, a removal of coffee powder from the storage container, while the storage container is held in the receptacle opening 36. For usage, the user opens the coffee filter holder 34, i.e., pivots it out, opens the storage container 70, and pours coffee powder in the desired quantity from the storage container 70 into the coffee filter using a metering spoon.

The coffee powder metering unit 80 comprises a first part 82 and a second part 84. The first part 82 can consist of a tube open at the top and bottom, which is dimensioned so that it can accommodate a container having coffee powder. The container having coffee powder is then inserted having an opening downward in the direction of second part 84. The bottom of the container having coffee powder is then used as a cover in the coffee powder metering unit. The container having coffee powder can be part of the coffee powder metering unit 80. The container can also be a container already filled with coffee powder to be acquired by purchase. The first part 82 can also be designed to directly accommodate coffee powder. In this case, the first part of the coffee powder metering unit can be equipped with a lid similar to the lid 72. The first part 82 can also be designed as a can, which is connected to the second part 84 having a bottom upward. For filling, the first part 82 is then detached from the second part 84, turned over and filled, and then connected to the second part 84 again. The first part 82 can comprise a stirring device for stirring the coffee powder, as will be explained in greater detail with reference to FIG. 6.

The second part 84 comprises a metering device and a drive for the metering device. Furthermore, the second part comprises a plug device 86, which offers an electrical interface to the coffee filter machine 30. Electrical energy is supplied from the main body to the drive of the metering device via the electrical interface 86 together with the electrical interface 54. The metering device is also activated via the electrical interface to cause coffee powder to fall into the coffee filter in the correct quantity.

In another embodiment, the second part 84 only contains the metering device and also the electrical interface 86. A drive for the metering device is arranged in the coffee filter machine 30, however. A coupling between the drive and the metering device is provided via the mechanical interface 59. A data transmission and an activation of the metering device can furthermore be ensured via the electrical interface 86 as described above.

The coffee grinder 90 comprises a grinding mechanism 92 and a coffee bean container 94. As stated in conjunction with the coffee powder metering unit, the coffee bean container 94 can also be embodied as a tube open at the top and bottom and can be dimensioned to accommodate a can having coffee bean container upside down, so that the bottom of the can provides a cover for the coffee beans. In another embodiment, the coffee bean container 94 is designed to accommodate loose coffee beans and comprises a lid. A ring 98 can be arranged at the upper edge or at the lower edge of the coffee bean container 94 and can be used for a manual grinding degree setting.

The grinding degree setting can also be performed in an electronically or mechanically controlled manner. This adjustment can take place directly from the pedestal and/or via mechanical and/or electronic interface to the coffee machine. The grinding mechanism 92 is equipped with an electrical interface 96, which cooperates or works together, like the interface 86, with the interface 54 and permits an energy and/or data transmission. The coffee powder dispensed by the grinding mechanism 92 falls through an opening, for example, the opening 56, at the bottom of the receptacle opening 36 into the coffee filter, wherein a closure element (not shown) can be provided as explained above. Grinding mechanism 92 and coffee bean container 94 can be detachably connected to one another. Grinding mechanism 92 and coffee bean container 94 can form a fixed unit.

FIGS. 5A and 5B each show the coffee filter machine system 60 having an inserted module. FIG. 5A shows the coffee filter machine system 60 having the coffee powder metering unit 80 inserted into the coffee filter machine 30. FIG. 5B shows the coffee filter machine 30 having inserted coffee grinder 90. It is immediately apparent from the comparison between the two illustrations in FIG. 5A and FIG. 5B that the modules do not have to have identical structural heights. Only the interfaces and the diameter and/or the formation of the receptacle device have to be adapted to the modules.

FIG. 6 shows, solely schematically, a view into the first part 82 of the coffee powder metering unit 80 having second part 84 located at the bottom. A stirring device 88 having two stirring arms protrudes into the first part (82), which accommodates the coffee powder. The stirring device can loosen the coffee powder by way of a rotation through the axis illustrated in the center. The parts of the stirring arms 88 extending along the bottom of the first part 82 can moreover push the coffee powder into a measuring volume (not shown). An activation of the stirring device can occur via the mechanical interface 59 or the electrical interface 54.

FIG. 7 shows, very schematically, the interfaces between the coffee filter machine 10 or the coffee filter machine 30, respectively, and a module on the basis of the example of the coffee grinder module 90. The grinding mechanism 92 has an opening 56 at its lower end, through which coffee powder can fall downward into the coffee filter holder 14. The opening 56 can be selectively closable by a cover 57. The coffee powder can thus be metered in one embodiment. In other embodiments, the cover 57 is not necessary and metering takes place via the duration during which the grinding mechanism works. The cover 57 can represent a closure element.

The grinding mechanism can be driven via the mechanical interface 59 (only shown schematically).

A plug 96 or an electrical interface 96 on the grinding mechanism 92 is connected to the interface 54 of the coffee filter machine. The connection of the two electrical interfaces 96, 54 ensures an electrical energy transmission and an electrical signal transmission.

The pedestal 22 with which the receptacle device 16 is equipped is clearly recognizable in FIG. 7. The coffee grinder 90 rests on the pedestal 22. Although the coffee grinder 90 is shown as a module for coffee storage by way of example in FIG. 7, a person skilled in the art understands that the coffee powder metering unit 80 interacts in similar form with the interfaces 54 and 59, and the coffee powder metering unit 80 is also equipped with an opening 56, through which coffee powder can fall into the coffee filter.

In one exemplary embodiment, the coffee filter machine 60 functions as follows. If the user inserts the coffee powder metering unit 80 into the receptacle opening 36, the electronic control unit 46 thus detects a coffee powder metering unit. It is therefore displayed on the display screen 48 that the coffee powder metering unit 80 is inserted. The user can now select on the display screen 48 how many cups of coffee he wishes to brew if the display screen is designed as a touchscreen. Otherwise, the user uses another provided human-machine interface for specifying the number of cups. In one embodiment, he can also determine the time when this coffee is to be brewed. The user pours water into the water container 44. He checks that the coffee powder metering unit 80 is filled with sufficient coffee powder. After actuating a start button or upon reaching the preselected time of day, respectively, the electronic control unit 46 firstly activates the coffee powder metering unit 80 and pours coffee powder for the desired number of cups into the coffee filter in accordance with the selection. The heating of the water then starts and the brewing water runs into the coffee filter and the finished coffee drips into the pot 42.

In another exemplary case, the user can wish for the coffee to be produced from freshly ground beans. For this purpose, he inserts the coffee grinder 90 into the receptacle opening 36. It is displayed on the display screen 48 that a coffee grinder is inserted. The user selects as before the desired number of cups of coffee, optionally the time of day, and pours water into the water tank. The user will also check here that the coffee bean container is sufficiently filled. After actuating a start button or upon reaching a starting time, respectively, firstly the coffee grinder is activated by the electronic control unit 46 and coffee is ground in accordance with the selection. This ground coffee falls directly into the coffee filter. The heating procedure subsequently begins and the brewing water drips into the coffee filter and the coffee runs into the coffee pot.

In another exemplary case, the user inserts a storage container 70 into the receptacle opening 36. If he wishes to brew coffee, he thus opens the storage container 70, pivots out the coffee filter holder 34, and pours coffee out of the coffee storage container into the coffee filter in accordance with his wishes. He does not have to hold the storage container in the hand or also put it down anywhere for this purpose. As before, the user pours water into the water container 44 and starts the brewing procedure with or without time switch.

FIGS. 8A and 8B show a coffee grinder system comprising a coffee grinder 90 and a coffee grinder base 100. The coffee grinder base 100 comprises a coffee powder collection container 102, which can be inserted into the coffee grinder base. The coffee grinder base furthermore contains an electrical fitting (not shown) for the power supply. The coffee grinder 90 can be placed on the coffee grinder base, wherein the plug 96 (FIG. 4D) works together with a plug 104 on the coffee grinder base. The coffee grinder is supplied with electrical current via the coffee grinder base and the ground coffee falls via an opening 106 into the coffee powder collection container 102. Alternatively (not shown in FIG. 8B), the coffee grinder base can also comprise a mechanical interface similar to the mechanical interface 59 (FIG. 3B, FIG. 7). In such an embodiment, the coffee grinder base 100 comprises a drive, and the coffee grinder 90 is activated via the mechanical interface. The possibility is provided by the coffee grinder base 100 of also using the coffee grinder 90 separately from the coffee filter machine 10 or 30, respectively.

Although specific embodiments have been illustrated and described, a person of average skill in the art understands that a plurality of alternative and/or equivalent implementations can be substituted for the specific embodiment shown and described without deviating from the fundamental concept of the present invention. The present invention is to cover all adaptations or variations of the specific embodiments explained herein.

1. A coffee filter machine comprising:
a main body,
a coffee filter holder, which is designed to hold a coffee filter,
a receptacle device, which is arranged above the coffee filter holder and is designed to detachably accommodate a module for coffee storage.

2. The coffee filter machine as claimed in claim 1, furthermore comprising an electronic control unit.

3. The coffee filter machine as claimed in claim 1, wherein the coffee filter holder is mounted so it is pivotable around a substantially vertical axis.

4. The coffee filter machine as claimed in claim 1, wherein the receptacle device comprises an electrical and/or a mechanical interface, which enables an electrical and/or mechanical energy transmission and/or signal transmission from the main body to the module for coffee storage and/or vice versa.

5. The coffee filter machine as claimed in claim 1, wherein the receptacle device is designed as a receptacle opening, which is substantially cylindrical, preferably having a circular bottom, and wherein the receptacle opening is open on top and facing away from the coffee filter holder.

6. The coffee filter machine as claimed in claim 5, furthermore comprising a water container, wherein the receptacle opening is arranged, preferably centrally, in the water container.

7. The coffee filter machine as claimed in claim 6, wherein the water container is detachably connected to the main body.

8. The coffee filter machine as claimed in claim 6, furthermore comprising a sensor device, which is designed to detect whether a module for coffee storage is inserted, and is preferably furthermore designed to detect a type of an inserted module for coffee storage.

9. The coffee filter machine as claimed in claim 8, wherein the sensor device is designed as a switch.

10. The coffee filter machine as claimed in claim 2, wherein an item of information about the type of the module for coffee storage is transmitted to the electronic control unit via the electrical interface.

11. A coffee filter machine system comprising
the coffee filter machine as claimed in claim 1, and at least one of the following modules for coffee storage:
storage container,
coffee powder metering unit,
coffee grinder.

12. The coffee filter machine system as claimed in claim 11, wherein the storage container is closed in a direction toward the coffee filter holder, and wherein the storage container permits a removal of coffee powder from the storage container while the storage container is held in the receptacle device.

13. The coffee filter machine system as claimed in claim 11, wherein the coffee powder metering unit comprises a first part, which is configured to accommodate coffee powder, and comprises a second part, which is configured to dispense coffee powder in a metered manner in the direction of the coffee filter holder.

14. The coffee filter machine system as claimed in claim 13, wherein the first part is configured to accommodate a container having coffee powder.

15. The coffee filter machine system as claimed in claim 13, wherein the first part comprises a stirring device for stirring the coffee powder.

16. The coffee filter machine system as claimed in claim 13, wherein the second part comprises a metering device and a drive for the metering device.

17. The coffee filter machine system as claimed in claim 13, wherein the second part comprises a metering device and the coffee filter machine comprises a drive for the metering device, wherein a coupling between the drive and the metering device is provided via the electrical and/or mechanical interface.

18. The coffee filter machine system as claimed in claim 11, wherein the coffee grinder comprises a grinding mechanism and a coffee bean container.

19. The coffee filter machine system as claimed in claim 18, wherein the grinding mechanism and the coffee bean container are detachably connected to one another.

20. The coffee filter machine system as claimed in claim 18, wherein the coffee bean container (94) is configured to accommodate a can having coffee beans.

21. The coffee filter machine system as claimed in claim 18, wherein the grinding mechanism comprises a grinding degree setting to be actuated manually.

22. The coffee filter machine system as claimed in claim 18, furthermore comprising a coffee grinder base, which is designed to accommodate the coffee grinder and supply it with electrical energy, wherein the coffee grinder base comprises a coffee collection container, which is arranged so that it can collect coffee powder ground by the grinding mechanism.

23. A coffee grinder system comprising the coffee grinder as described in claim 18, and the coffee grinder base as described in claim 22.
